(19) United States
(12) Patent Application Publication
(10) Pub. No.: US 2005/0105822 A1
(43) Pub. Date: May 19, 2005

(54) Variable distortion aberration image pickup device

(76) Inventor: Yoshinori Narita, Saitama-Shi (JP)

Correspondence Address: JACOBSON HOLMAN PLLC, 400 SEVENTH STREET N.W., SUITE 600, WASHINGTON, DC, 20004, US

(21) Appl. No.: 10/989,291

(22) Filed: Nov. 17, 2004

(30) Foreign Application Priority Data
Nov. 18, 2003 (JP) 2003-387931

(51) Int. Cl. G06K 9/40

(52) U.S. Cl. 382/275

(57) ABSTRACT

The present invention is directed to a variable distortion aberration image pickup device that is capable of varying distortion aberration with its center at any desired point either inside or outside an image where, specifically, distortion aberration is effectively developed and/or eliminated with the distortion center at any desired point both inside and outside the image as desired, and such an image pickup device is also capable of varying distortion aberration with its center at a desired point either inside or outside the image, separately in individual directions, where specifically an image is processed so as to have distortion aberration with its center at any desired point both inside and outside the image, with varied distortion ratios from one direction to another. For that purpose, the variable distortion aberration image pickup device is comprised of a photograph lens, two-dimensional opto-electronic feedback elements, and a distortion aberration conversion circuit that receives output image signals from the two-dimensional opto-electronic feedback elements to dislocate a desired point of an image in some direction(s) from the given center of distortion.

### FIELD OF THE INVENTION

The present invention relates to a variable distortion aberration image pickup device that is capable of both artificially distorting an image of an object where the image is edited to reproduce a barrel-shaped swelled object or reversely a pincushion-shaped squeezed object so that the resultant image is funny and enjoyable to see and artificially correcting an anamorphic image of an object to result in the image without distortion, precisely reproducing the object.

### BACKGROUND ART

As for the prior art image pickup devices capable of distorting an object image omnidirectionally with varied distortion ratios depending upon a distance from a predetermined position or capable of correcting an anamorphic image of an object to create the image without distortion, there have been proposed those as mentioned below.

One proposed method in the prior art is varying a magnification/reduction ratio between the primary and secondary scanning directions in an electronic magnification/reduction process, thereby permitting a simple image processing architecture to magnify or reduce image data in a single direction at an accelerated processing speed (e.g., see Patent Document 1).

An exemplary image pickup device in the prior art is capable of correcting distortion aberration only when a user intends to. Specifically, CCD (charge coupled device) solid state imaging sensor produces an optical image of an object focused on its picture plane by a photographic lens and outputs opto-electronically transduced image data. The image data are stored in a form of digitized data in a frame memory. When the user shifts a mode-selecting switch to turn on a distortion correcting mode, the image data in the frame memory is read out by a distortion correcting arithmetic operation unit to process the image for compensation for the distortion aberration. The distortion correcting arithmetic operation unit enables a display unit and a memory unit to respectively reproduce and store the corrected image. When the user uses the mode-selecting switch to shift to a non-correcting mode, the image data are directly transferred from the frame memory to the memory unit and the display unit to enable them to store and reproduce the image data. The electronic camera configured in this manner attains the control of its aberration correcting feature as desired during the image processing (e.g., see Patent Document 2).

As for accelerated processing method and apparatus more suitable for a practical use, there also have been proposed those as mentioned below. Exemplary cost reduced, accelerated and practical image processing method and apparatus can process a photographic image in both a first direction and a second direction orthogonal to the same for the separate purposes of correcting chromatic aberration of magnification, correcting distortion aberration, and electronically varying magnification/reduction ratio, one at a time, where when an amount of the correction is different between the first and second directions, the method and apparatus proceed with the image processing first for the direction requiring the smaller correction, so that even if an image is focused on film incorporating a lens of a relatively large aberration property, a high quality image can be reproduced without chromatic deviation and distortion through the image processing of correcting the chromatic aberration of magnification and the distortion aberration depending upon the aberration property unique to the lens (e.g., see Patent Document 3).

Another image pickup apparatus capable of correcting distortion aberration has been disclosed as in the following example. When a barrel deviation aberration is to be corrected, a circle concentric with the center circle of an image area (fixed circle) is defined to be inscribed in the image area. A lookup table for distortion aberration correction should be created as well in advance so as to be indicative of which pixel and its data should actually be employed to reproduce an individual image from the optical data obtained by an image pickup device. For the pixels existing outside the fixed circle, the distortion aberration correction is also carried out by a simplified process, effectively using the obtained data as much as possible, where the optical data from the pixels for which the distortion aberration correction is indicated in the lookup table are replaced with the optical data from the pixels closer to the center (e.g., see Patent Document 4).

Additionally disclosed has been a compensation device capable of correcting/displaying an anamorphic image with distortion aberration. An imaging unit receives the anamorphic image with the distortion aberration from an ITV camera which has a fish-eye lens or a super wide-angle lens built therein, and the compensation device converts the received image into digitized signal data, corrects the full range or the partial specified range of the image to an image without the distortion aberration, and then displays the corrected image data on a picture plane of an image display unit (e.g., see Patent Document 5). According to the technology set forth in Patent Document 5, any desired part of the image data can be stored in memory, if desired.

List of the Patent Documents Cited Above:
Document 1: Japanese Patent Preliminary Publication No. 2000-78390,
Document 2: Japanese Patent Preliminary Publication No. H11-275444,
Document 3: Japanese Patent Preliminary Publication No. H11-313214,
Document 4: Japanese Patent Preliminary Publication No. H11-331628, and
Document 5: Japanese Patent Preliminary Publication No. H08-305841.

Allowing for the above-mentioned disadvantages in the prior art, the present invention is made to overcome them, and above all, one significant problem with the fish-eye lens is that the center of distortion always coincides with the center of the image, and hence, it is impossible to reproduce an artificially distorted image where its distortion center is the desired part of an object such as the nose of a person that is off the center of an image frame, depending upon the desired layout of components of the object or the image.

Although, as in the disclosure of Patent Document 1, it is possible to vary the distortion ratio from one direction of the image to another, a component of an object, such as the nose of a person, off the center of the image frame cannot be the distortion center in reproducing the artificially distorted image.

The technology disclosed in Patent Document 2 simply enables a user's choice of correcting or not the distortion aberration, and it is impossible to reproduce the artificially distorted image of which distortion center coincides with a component of an object, such as the nose of a person, off the center of the image frame.

The technology disclosed in Patent Document 3 enables the image to have varied distortion ratio from one direction to another, and in order to enhancing effectiveness, the image is processed in the direction at the smaller compensation ratio first, which does not mean that technology permits a creation of an anamorphic image with a distortion center such as the nose of a person located off the center of the image frame, depending upon the desired layout of components of the object or the image.

Although the lookup table is used to compensate the distortion aberration in Patent Document 4, the distortion aberration compensation employed therein is performed based upon distances from the center of the image, and the disclosed technology does not enable a creation of an anamorphic image with the distortion center such as the nose of a person located off the center of the image frame.

Although the technology disclosed in Patent Document 5 permits the interpolating for any desired point of the data, it yet is not capable of creating an anamorphic image with the distortion center such as the nose of a person located off the center of the image frame.

Accordingly, it is an object of the present invention to provide a variable distortion aberration image pickup device that is capable of varying distortion aberration with its center at any desired point either inside or outside an image where, specifically, distortion aberration is effectively developed and/or eliminated with the distortion center at any desired point both inside and outside the image as desired.

It is another object of the present invention to provide a variable distortion aberration image pickup device capable of varying distortion aberration with its center at any desired point either inside or outside the image, separately in individual directions, where specifically an image is processed so as to have distortion aberration with its center at any desired point both inside and outside the image, with varied distortion ratios from one direction to another.

### SUMMARY OF THE INVENTION

The present invention is directed to a variable distortion aberration image pickup device that comprises a photograph lens, two-dimensional opto-electronic feedback elements, and a distortion aberration conversion circuit receiving output image signals from the two-dimensional opto-electronic feedback elements to dislocate a desired point of an image in some direction(s) from the given center of distortion.

In an aspect of the present invention, the distortion aberration conversion circuit is capable of determining the center of distortion inside or outside the image.

In another aspect of the present invention, the distortion aberration conversion circuit is capable of displacing the center of distortion inside or outside the image.

In still another aspect of the present invention, the distortion aberration conversion circuit selects a direction from the center of distortion to displace the image in the selected direction and its adjacent directions).

In yet another aspect of the present invention, the distortion aberration conversion circuit displaces a desired point of the image toward the center of distortion.

In further another aspect of the present invention, the distortion aberration conversion circuit displaces a desired point of the image in some directions far from the center of distortion.

Given that concentric circles c1, c2, c3 and so on about the center of distortion P pass m segmentation points obtained by equally dividing an extension from the distortion center to the outermost periphery of the image into m segments, with their respective radii being designated by r1, r2, r3, and so forth, the distortion aberration conversion circuit processes the image based on the following formulae:
D=sin(90°×n/m)
where D is a coefficient of distortion for the n-th concentric circle from the distortion center P, and
D×K
which expresses a displacement of the desired point of the image where K is the maximum distortion ratio, namely, the degree of distortion of the image at its outermost peripheral area farthest from the center of distortion.

Thus, in accordance with the present invention, the variable distortion aberration image pickup device attains an effect of varying distortion aberration of an image with the center of distortion aberration at any desired location either inside or outside the same, or more specifically, it attains an effect of developing and/or eliminating distortion aberration with its center at any desired location both inside and outside the image so as to vary the same.

Also, in accordance with the present invention, the device further provides a feature of varying distortion aberration with its center at any desired location either inside or outside an image, separately in individual directions, and more specifically, it attains an effect of creating an image of varied distortion aberration ratios from one direction to another with the center of distortion at any desired location both inside and outside the image.

### BRIEF DESCRPTION OF THE DRAWINGS

FIG. 1 is a block diagram showing an exemplary variable distortion aberration image pickup device according to the present invention;

FIG. 2 is a block diagram showing a coordinate conversion parameter unit of the exemplary variable distortion aberration image pickup device according to the present invention;

FIG. 3 is a diagram illustrating a coefficient of distortion;

FIG. 4 is a graph illustrating a displacement of a given portion of an image in the process for an image with barrel distortion according to the present invention; and

FIG. 5 is a graph illustrating a displacement of a given portion of an image in the process for an image with pincushion distortion according to the present invention.

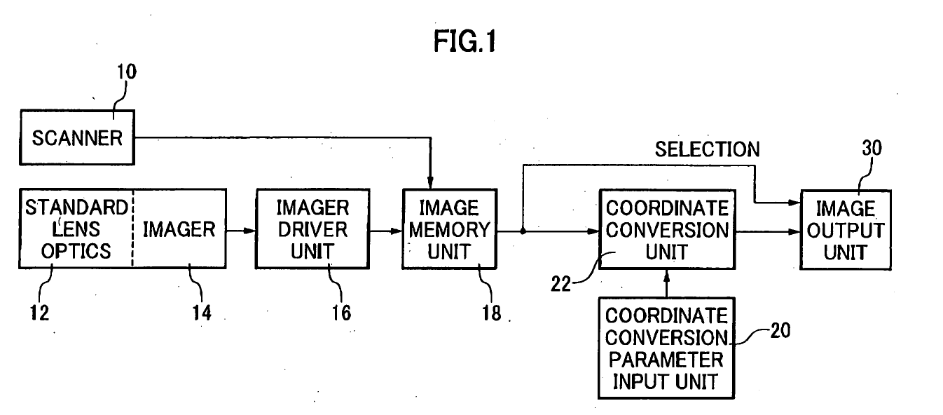

### DETAILED DESCRIPTION OF THE INVENTION

Best Mode of the Embodiments of the Invention

Best mode of the preferred embodiments of the invention will be described in detail below.

### Embodiment 1

An exemplary variable distortion aberration image pickup device according to the present invention is designed to create a distortion aberration picture plane symmetric in respect to the center of symmetry and a distortion aberration compensation picture plane symmetric in respect to the axis of symmetry.

The signal processing is carried out through the scanning of an image of an object by a scanner 10 or the activation of an imager 14 with a standard lens optics 12 by an imager driver unit 16 so as to input an image signal to an image memory unit 18. A coordinate conversion unit 22 receives the image signal through the image memory unit 18 and also receives coordinate conversion parameters trough a coordinate conversion parameter input unit 20. The coordinate conversion unit 22 uses the coordinate conversion parameters to process the image signal by varying distortion aberration therein and produces the revised image signal to an image output unit 30. The image signal received from the image memory unit 18 may be transferred to the image output unit 30, without undergoing the coordinate conversion.

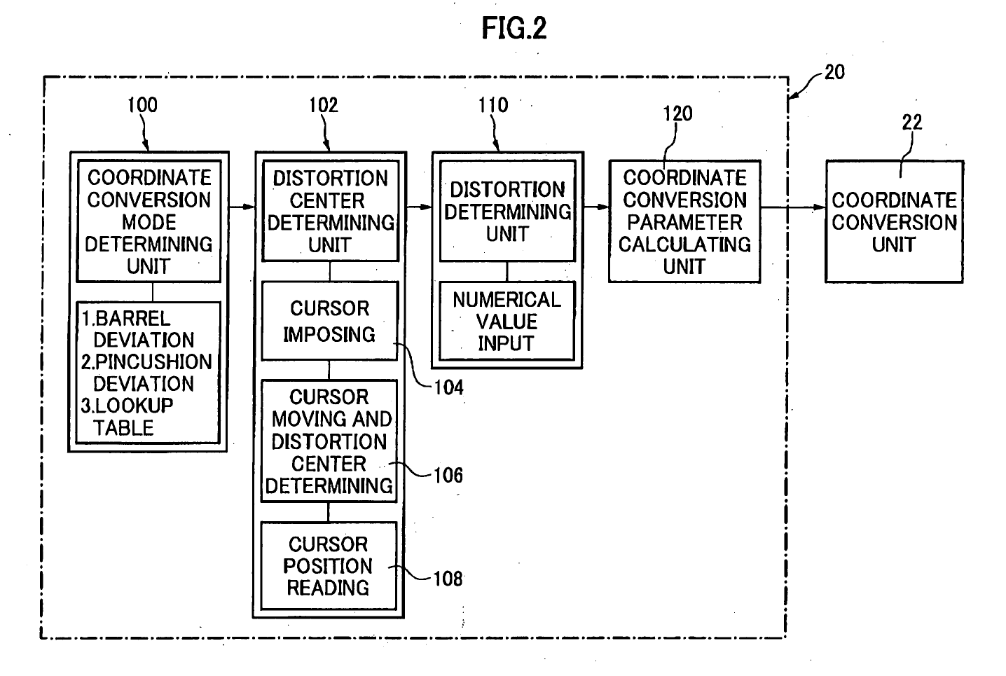

The coordinate conversion parameter input unit 20, as illustrated in FIG. 2, has a coordinate conversion mode determining unit 100 that functions to select a distortion mode as desired from a barrel deviation, a pincushion deviation, or other types of deviation contained in the lookup table each of which distortion ratio is variable as desired.

The coordinate conversion parameter input unit 20 also has a distortion center determining unit 102, distortion determining unit 110 and a coordinate conversion parameter calculating unit 120. The distortion center determining unit 102 carries out cursor imposing 104, cursor moving and distortion center determining 106 and cursor position reading 108. The distortion determining unit 110 inputs numerical value.

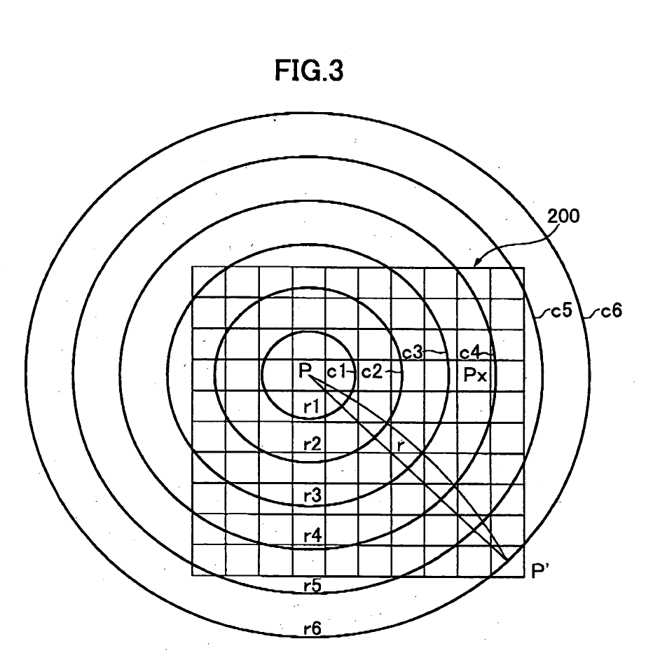

A coefficient of distortion for the barrel or pincushion distortion, which is a coefficient used in dislocating the original coordinates for distortion, is determined on the sinusoidal conditions, namely, on the sine curve. For instance, as illustrated in FIG. 3, concentric circles c1, c2, . . . , c6 are first to be assumed about the distortion center P, with their respective radii being designated by r1, r2, . . . , r6.

A coefficient of distortion D is zero at the distortion center P. Allowing for the coefficient of distortion D for each of the concentric circles that pass m segmentation points obtained by equally dividing an extension from the distortion center to the outermost periphery of the image into m segments, the coefficient of distortion D for the n-th circle from the distortion center P is given as follows:
D=sin(90°×n/m)

Assuming now that m is equal to 6 (m=6), the coefficient of distortion D can be given for the distortion center P, the concentric circles c1 to c5, and the outermost periphery c6, respectively, as follows:
For the distortion center P, D=sin(90°×0/6)=sin 0°=0.00;
for the circle c1, D=sin(90°×1/6)=sin 15°=0.26;
for the circle c2, D=sin(90°×2/6)=sin 30°=0.50;
for the circle c3, D=sin(90°×3/6)=sin 45°=0.71;
for the circle c4, D=sin(90°×4/6)=sin 60°=0.87;
for the circle c5, D=sin(90°×5/6)=sin 75°=0.97; and
for the outermost periphery c6, D=sin(90°×6/6)=sin 90°=1.00.

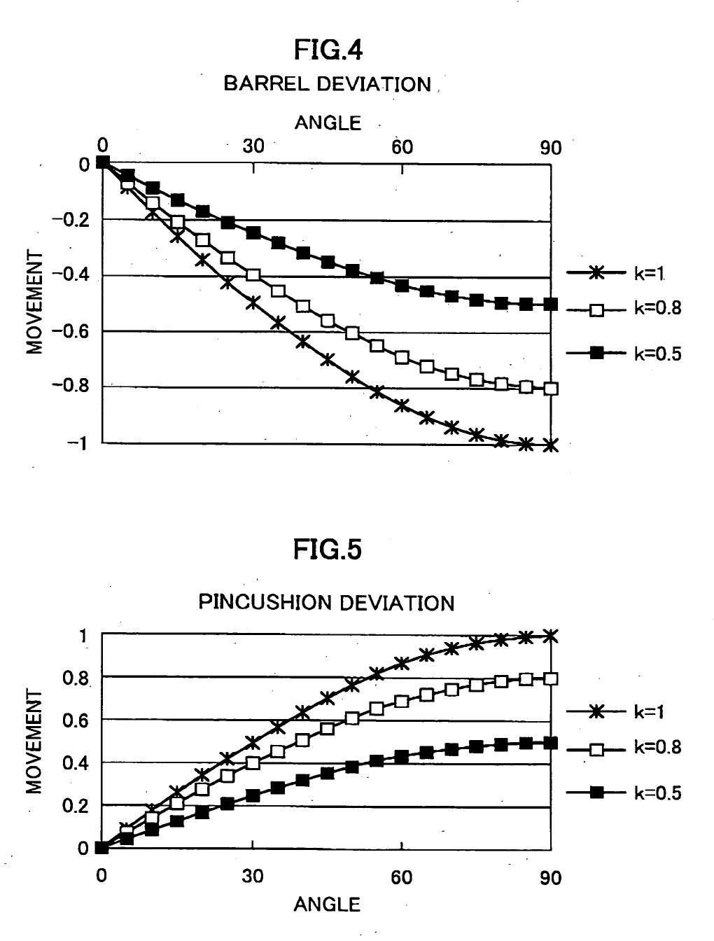

Assuming that an amount of distortion of the image at its outermost peripheral region farthest from the distortion center is expressed as the maximum distortion ratio K (mm), a displacement of each of the concentric circles after the distortion or the distortion compensation is given as follows:
For the distortion center P, 0 (mm);
for the circle c1, 0.26K (mm);
for the circle c2, 0.50K (mm);
for the circle c3, 0.71K (mm);
for the circle c4, 0.87K (mm);
for the circle c5, 0.97K (mm); and
for the outermost periphery c6, 1.00K (mm).
   When an image without distortion aberration is processed and dislodged as in the aforementioned manner by a negative displacement, the resultant image assumes a barrel distortion as illustrated in the graph in FIG. 4. When dislodged by a positive displacement, the resultant image assumes a pincushion distortion as shown in the graph in FIG. 5.

FIGS. 4 and 5 respectively show a displacement for each of the following conditions:
K=1.0;
K=0.8; and
K=0.5.
   The values of the displacement as in FIGS. 4 and 5 are presented as representatives to illustrate a comprehensive tendency, and the remaining values among any set of the adjacent values can be interpolated by some well-known mathematical method.

### Embodiment 2

An additional preferred embodiment of the present invention is designed to produce an image symmetric about a point other than the center of distortion, and hence, the resultant image on the picture screen is different from an image compensated for the distortion aberration symmetrically in respect to the center of distortion. In other words, the image eventually obtained is that which has the image dislodged from a given reference center as desired with varied distortion aberration ratios from one direction to another, or compensated for distortion aberration from the reference center with varied displacement ratios from one direction to another.

In this embodiment, the maximum distortion ratio K (mm) from the given reference center as desired is varied from one direction to another. The maximum distortion ratio K (mm) between any set of the adjacent directions can be interpolated by some well-known mathematical method.

### Embodiment 3

In the aforementioned Embodiments 1 and 2, the coefficient used to dislodge the original coordinates is determined based upon the sine curve. In this additional embodiment, however, such a coefficient used to dislodge the original coordinates is determined on the square function curve, or curves or lines preprogrammed and contained in the lookup table.

As has been described, one of the objects of the present invention is to facilitate to produce a funny and enjoyable image from an original image without distortion aberration by artificially developing distortion aberration with its center at any location in the image. In addition, the invention attained in such a manner uses a simplified image pickup device to enable the original image with distortion aberration to be transformed in a perfect image without distortion aberration. Moreover, successively varying the center of distortion and/or the degree of distortion for amusement permits the resultant image to have funny and enjoyable effects.

1. A variable distortion aberration image pickup device comprising a photograph lens, two-dimensional opto-electronic feedback elements, and a distortion aberration conversion circuit receiving output image signals from the two-dimensional opto-electronic feedback elements to dislocate a desired point of an image in some direction(s) from the given center of distortion.

2. A variable distortion aberration image pickup device according to claim 1, wherein the distortion aberration conversion circuit is capable of determining the center of distortion inside or outside the image.

3. A variable distortion aberration image pickup device according to claim 1, wherein the distortion aberration conversion circuit is capable of displacing the center of distortion inside or outside the image.

4. A variable distortion aberration image pickup device according to claim 1, wherein the distortion aberration conversion circuit selects a direction from the center of distortion to displace the image in the selected direction and its adjacent directions.

5. A variable distortion aberration image pickup device according to claim 1, wherein the distortion aberration conversion circuit displaces a desired point of the image toward the center of distortion.

6. A variable distortion aberration image pickup device according to claim 1, wherein the distortion aberration conversion circuit displaces a desired point of the image in some directions far from the center of distortion.

7. A variable distortion aberration image pickup device according to claim 1, wherein given that concentric circles c1, c2, c3 and so on about the center of distortion P pass m segmentation points obtained by equally dividing an extension from the distortion center to the outermost periphery of the image into m segments, with their respective radii being designated by r1, r2, r3, and so forth, the distortion aberration conversion circuit processes the image based on the following formulae:
D=sin(90°×n/m)
where D is a coefficient of distortion for the n-th concentric circle from the distortion center P, and
D×K
which expresses a displacement of the desired point of the image where K is the maximum distortion ratio, namely, the degree of distortion of the image at its outermost peripheral area farthest from the center of distortion.
